(19) United States
(12) Patent Application Publication
(10) Pub. No.: US 2014/0215118 A1
(43) Pub. Date: Jul. 31, 2014

(54) SWITCHING CIRCUIT, SEMICONDUCTOR DEVICE, AND ELECTRONIC APPARATUS

(71) Applicant: Kabushiki Kaisha Toshiba, Tokyo (JP)

(72) Inventors: Koichi Senuma, Ome-shi (JP); Kazuhiro Nakamura, Hachioji-shi (JP)

(73) Assignee: Kabushiki Kaisha Toshiba, Tokyo (JP)

(21) Appl. No.: 14/010,820

(22) Filed: Aug. 27, 2013

Related U.S. Application Data
(63) Continuation of application No. PCT/JP2013/058512, filed on Mar. 25, 2013.

(30) Foreign Application Priority Data
Jan. 31, 2013 (JP) 2013-017898

(51) Int. Cl. G06F 13/40

(52) U.S. Cl. CPC G06F 13/4022
USPC 710/316

(57) ABSTRACT

According to one embodiment, a switching circuit includes a device, a load switch, a device bus to which the device is connected, a device bus terminating resistor, a bus switch, and a host bus terminating resistor. The load switch feeds power to the device when a control signal is active. The device bus terminating resistor terminates the device bus. The bus switch connects a host bus and the device bus when the control signal is active or when the load switch is in a feed state. The host bus terminating resistor terminates the host bus when the host bus and the device bus are disconnected.

### CROSS-REFERENCE TO RELATED APPLICATIONS

This application is a Continuation Application of PCT Application No. PCT/JP2013/058512, filed Mar. 25, 2013 and based upon and claiming the benefit of priority from Japanese Patent Application No. 2013-017898, filed Jan. 31, 2013, the entire contents of all of which are incorporated herein by reference.

### FIELD

Embodiments described herein relate generally to a switching circuit, a semiconductor device, and an electronic apparatus.

### BACKGROUND

Ways of adjusting terminating resistor in a circuit have been contrived. They are such as providing means for detecting the number of loads connected to a bus line to switch a value of terminating resistance, detecting the number of additional boards which are connected, and providing a variable resistor inside a chip.

However, although there are demands for a technology by which a value of the terminating resistance can more be easily switched, means for fulfilling such demands are not known.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram illustrating a system configuration of a personal computer according to the present embodiment.

FIG. 2 is a block diagram illustrating details of a part of the embodiment.

FIG. 3A is a diagram for describing an I²C (IIC) interface to be used in an embodiment.

FIG. 3B is another diagram for describing an I²C interface to be used in an embodiment.

FIG. 4 is a block diagram illustrating another example of a part of the embodiment.

### DETAILED DESCRIPTION

Various embodiments will be described hereinafter with reference to the accompanying drawings.

In general, according to one embodiment, a semiconductor device includes a first device, a load switch, a device bus, and a device bus terminating resistor. The load switch feeds power to the first device when a control signal is active. The first device is connected to the device bus. The device bus terminating resistor terminates the device bus.

According to another embodiment, a switching circuit includes a device, a load switch, a device bus to which the device is connected, a device bus terminating resistor, a bus switch, and a host bus terminating resistor. The load switch feeds power to the device when a control signal is active. The device bus terminating resistor terminates the device bus. The bus switch connects a host bus and the device bus when the control signal is active or when the load switch is in a feed state. The host bus terminating resistor terminates the host bus when the host bus and the device bus are disconnected.

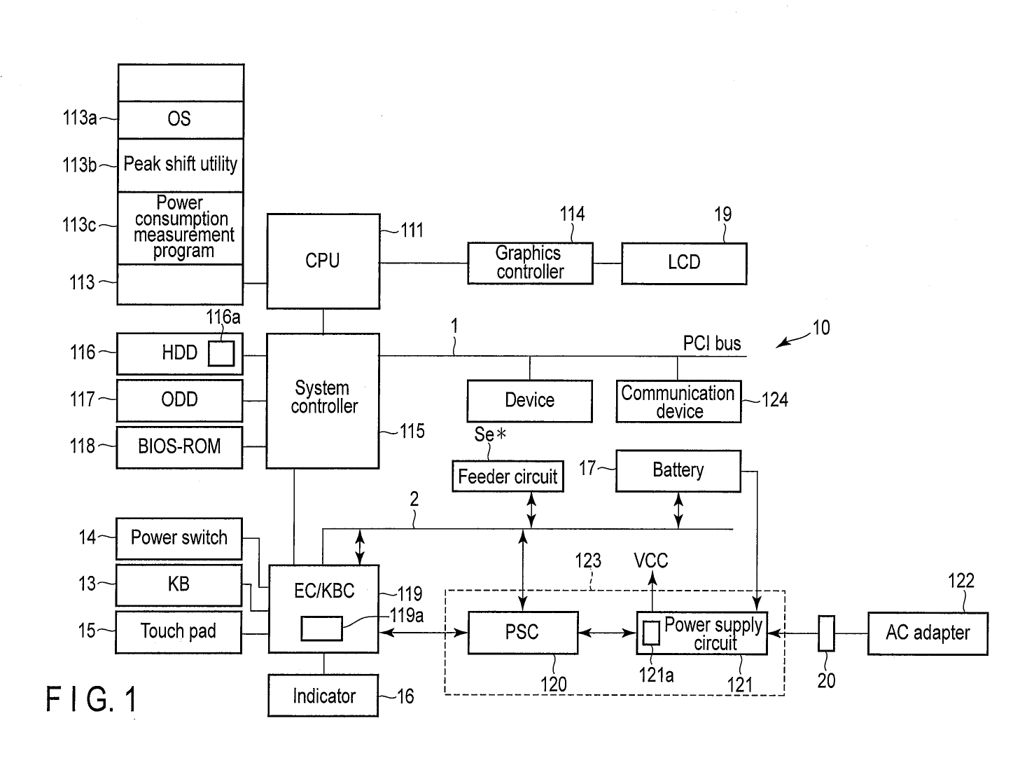

An embodiment will be described with reference to FIGS. 1 to 4. Firstly, FIG. 1 is a block configuration diagram which shows an embodiment of the electronic apparatus.

With reference to FIG. 1, a structure of an electronic apparatus according to the embodiment of an information processing device will be described. The electronic apparatus is realized as a note-book type portable personal computer 10 which can be driven by a battery, for example.

That is, FIG. 1 shows a system configuration of the personal computer 10. The personal computer 10 comprises a CPU 111, a main memory 113, a graphics controller 114, a system controller 115, a hard disk drive (HDD) 116, an optical disk drive (ODD) 117, a BIOS-ROM 118, an embedded controller/keyboard controller (EC/KBC) 119, a power supply controller (PSC) 120, a power supply circuit 121, an AC adapter 122, etc. The AC adapter 122 is used as an external power supply device. In the present embodiment, the power supply controller (PSC) 120 and the power supply circuit 121 function as a power consumption measuring circuit 123 for measuring an amount of power from the external power supply device (AC adapter). The power consumption measuring circuit 123 measures the amount of power not only in a period in which the personal computer 10 is powered on, but also in a period in which the same is powered off. In the present embodiment, power supplied from the external power supply device (AC adapter), for example, is treated as the power consumed in the personal computer 10. The EC/KBC 119, which is the measurement means for measuring the amount of power, reads the amount of power (current value, voltage value) measured by the power consumption measuring circuit 123, namely, data which indicates a power consumption value, and outputs the same to the CPU 111 (operating system (OS)) through the system controller 115.

The CPU 111 is a processor which controls the operation of each component of the personal computer 10. The CPU 111 executes various kinds of software loaded into the main memory 113 from the HDD 116, for example, an operating system (OS) 113a and various utility programs and application programs. As these various utility programs and application programs, there are a peak shift utility 113b and a power consumption measurement program 113c.

In addition, the CPU 111 also executes a BIOS (Basic Input Output System) stored in the BIOS-ROM 118, which is nonvolatile memory. The BIOS is a system program for controlling hardware.

The graphics controller 114 is a display controller which controls an LCD 19 to be used as a display monitor of the personal computer 10.

The system controller 115 is connected to a PCI bus 1, and executes communication with each device on the PCI bus 1. A communication device 124, for example, is connected to the PCI bus 1. The communication device 124 controls communication with an external device (for example, a data server) through a network under the control of the CPU 111. Further, in the system controller 115, a Serial ATA controller for controlling the hard disk drive (HDD) 116 and the optical disk drive (ODD) 117 is embedded.

The EC/KBC 119, the power supply controller (PSC) 120, and the battery 17 are connected to each other by a serial bus 2, such as an I2C bus, and the EC/KBC 119 is connected to the system controller 115 via an LPC bus. The EC/KBC 119 is a power management controller for executing power management of the personal computer 10, and is realized as a one-chip microcomputer with a built-in keyboard controller for controlling a keyboard (KB) 13 and a touch pad 15, for example. The EC/KBC 119 has the function of powering on and powering off the personal computer 10 in accordance with an operation of a power switch 14 by a user. The power-on and power-off control of the personal computer 10 is executed by a cooperative operation between the EC/KBC 119 and the PSC 120. When an on signal transmitted from the EC/KBC 119 is received, the PSC 120 controls the power supply circuit 121 and turns on each internal power source of the personal computer 10. Further, when an off signal transmitted from the EC/KBC 119 is received, the PSC 120 controls the power supply circuit 121 and turns off each internal power source of the personal computer 10. The EC/KBC 119, the PSC 120, and the power supply circuit 121 operate by the power supplied from the battery 17 or the AC adapter 122 even during a period in which the personal computer 10 is powered off.

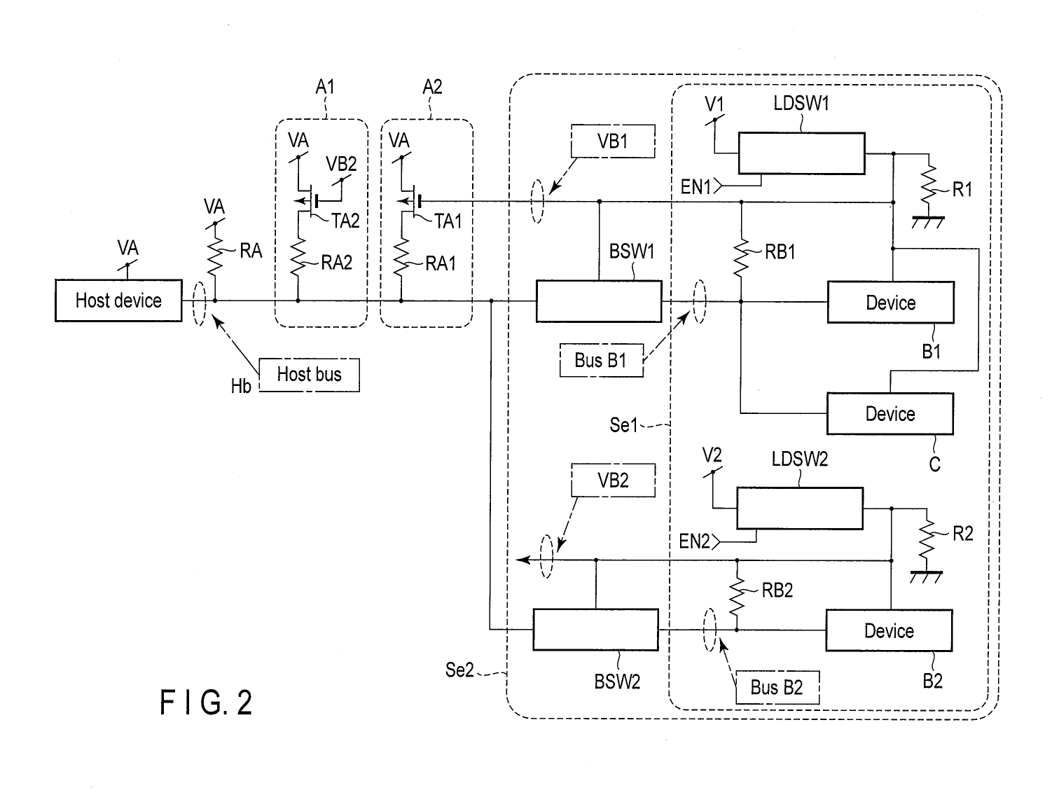

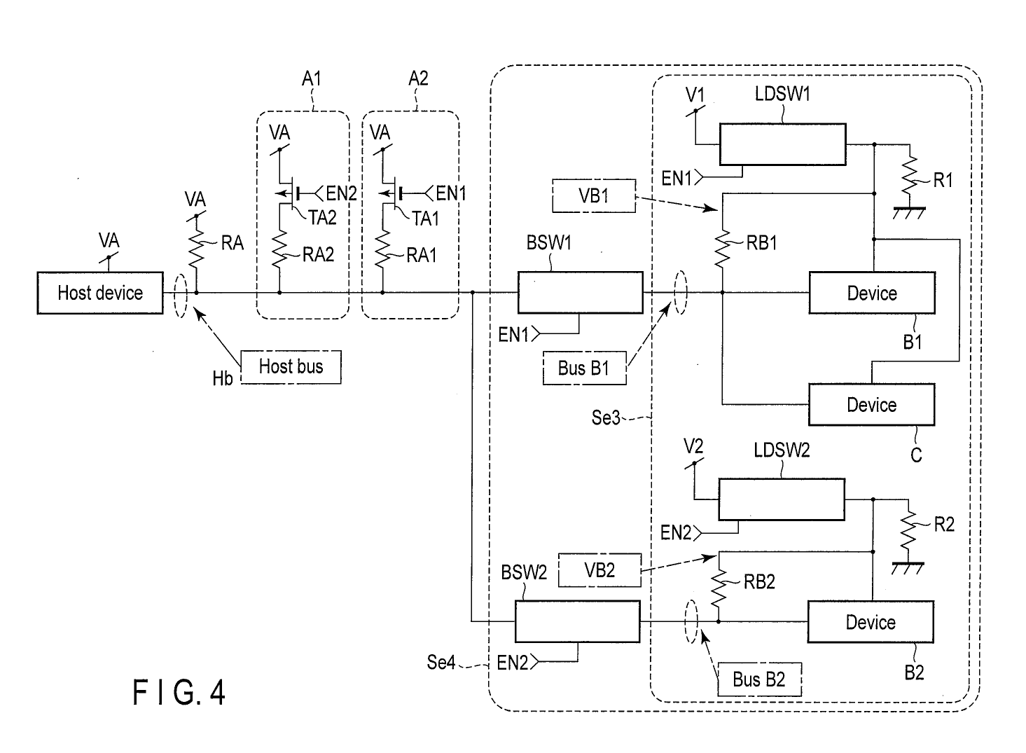

Further, feeder circuit Se* is a semiconductor device which is a part of a switching circuit configured to feed power to an internal device mentioned in FIGS. 2 and 4 and to stop the same (*=1 to 4). As specific examples of the devices to which feeder circuit Se* is connected, there are a human I/F device, such as a touch panel, a touch pad, etc., and sensors, such as an acceleration sensor, a magnetic sensor, a temperature sensor, an illuminance sensor, a camera, etc. When these devices do not need to be operated, power of these devices is turned off. At the same time, while these devices must be isolated from the serial bus, a value of terminating resistance of the bus is adjusted for the PSC or the battery, for example, existing on the same bus and must continue to operate.

FIG. 2 is an example according to the present embodiment. The example shows that three devices, which are device B1, device B2, and device C, are connected to a host bus which is controlled an I²C host. The following description also applies to a host bus other than the I²C bus.

A function and a structure of hardware connection, etc., will be described with reference to FIG. 2. Firstly, a host device, which is the master device, is configured to communicate data among each slave device, device B1, device B2, and device C. That is, device B1 communicates data with the host device. Further, device B2 communicates data with the host device. Device C communicates data with the host device.

Next, host bus Hb is a bus line of the host device. Of each of the slave buses (device buses), bus B1 is a bus line of device B1 and device C. Further, the next slave bus B2 is a bus line of device B2.

Further, VA is a power source of the host device. V1 is a power source. V2 is a power source. VB1 is a power source of device B1 and device C. VB2 is a power source of device B2.

LDSW1 is a load switch inserted between power source V1 and power source VB1. EN1 is a control signal of load switch LDSW1. Load switch LDSW1 is turned on when the control signal is active, and turned off when the control signal is inactive.

LDSW2 is a load switch inserted between power source V2 and power source VB2. EN2 is a control signal of load switch LDSW2. Load switch LDSW2 is turned on when the control signal is active, and turned off when the control signal is inactive.

BSW1 is a bus switch. This bus switch is turned on when power source VB1 is at a predetermined potential, and turned off when power source VB1 is at ground potential.

BSW2 is also a bus switch. This bus switch is turned on when power source VB2 is at a predetermined potential, and turned off when power source VB2 is at ground potential.

RA is a resistor connected between power source VA and host bus Hb. Resistor RA is determined such that a value of combined resistance of resistor RB1 and resistor RB2 is appropriate. RA1 is a resistor. RA2 is also a resistor.

TA1 is a P-MOS transistor. If a gate potential of transistor TA1 is higher than or equal to power source VA (gate potential of transistor TA1 power source VA), transistor TA1 is turned off. Further, if the gate potential of transistor TA1 is lower than power source VA (gate potential of transistor TA1<power source VA), transistor TA1 is turned on.

TA2 is also a P-MOS transistor. If a gate potential of transistor TA2 is higher than or equal to power source VA (gate potential of transistor TA2 power source VA), transistor TA2 is turned off. Further, if the gate potential of transistor TA2 is lower than power source VA (gate potential of transistor TA2<power source VA), transistor TA2 is turned on.

RB1 is a terminating resistor connected between power source VB1 and bus B1. RB2 is a terminating resistor connected between power source VB2 and bus B2.

R1 is a resistor which draws the charge of power source VB1 when load switch LDSW1 is turned off. R2 is a resistor which draws the charge of power source VB2 when load switch LDSW2 is turned off.

Constituent features excluding power components may suitably be structured by a semiconductor device (such as integrated circuits known as IC and LSI) in the category of Se1 or Se2, for example. Further, the devices may take the form of being provided externally variously on the semiconductor device.

The operation in the structure of the function and hardware connection, etc. described above will be summarized as follows:

(1) When power sources VA, V1, and V2 are turned on and control signals EN1 and EN2 are active, load switch LDSW1 is ON, load switch LDSW2 is ON, bus switch BSW1 is ON, bus switch BSW2 is ON, transistor TA1 is OFF, and transistor TA2 is OFF.

This state is a standard state which allows the host device to communicate with all of device B1, device B2, and device C.

Host bus Hb, bus B1, and bus B2 are electrically connected with each other by bus switch BSW1 and bus switch BSW2, and these host bus Hb, bus B1, and bus B2 terminate at combined resistance, which is the parallel resistance of RA, RB1, and RB2 (parallel resistance “RA//RB1//RB2”).

(2) For the reason of power saving, etc., there is a demand to turn off power of devices which are not working when a system is energized.

When the power of device B1 and device C is to be turned off, load switch LDSW1 is turned off by making control signal EN1 inactive, and power source VB1 is turned off.

Simultaneously, in order to prevent a current from leaking into device B1, device C, and resistor RB1, the host device and bus B1 need to be electronically isolated from each other. In the present example, this is carried out by bus switch BSW1, and bus B1 is disconnected from host bus Hb as power source VB1 is turned off (VB1=ground potential).

(3) If host bus Hb and bus B1 are electronically isolated from each other as stated in above (2), resistor RB1 is also isolated from host bus Hb. On the other hand, because power source VB1 is turned off (VB1=ground potential), transistor TA1 is turned on and resistor RA1 is connected to host bus Hb.

As a result, the terminating resistance is switched from combined resistance “RA//RB1//RB2” to combined resistance “RA//RA1//RB2”. If the value of resistance of resistor RA1 is made equal to that of resistor RB1, the above values of combined resistance can be made the same.

(4) If the devices need to be operated again, control signal EN1 may be made active.

(5) If the power of device B2 is to be turned off, control signal EN2 may be made inactive.

The terminating resistance is switched from combined resistance “RA//RB1//RB2” to combined resistance “RA//RB1//RA2”. If the value of resistance of resistor RA2 is made equal to that of resistor RB2, the above values of combined resistance can be made the same.

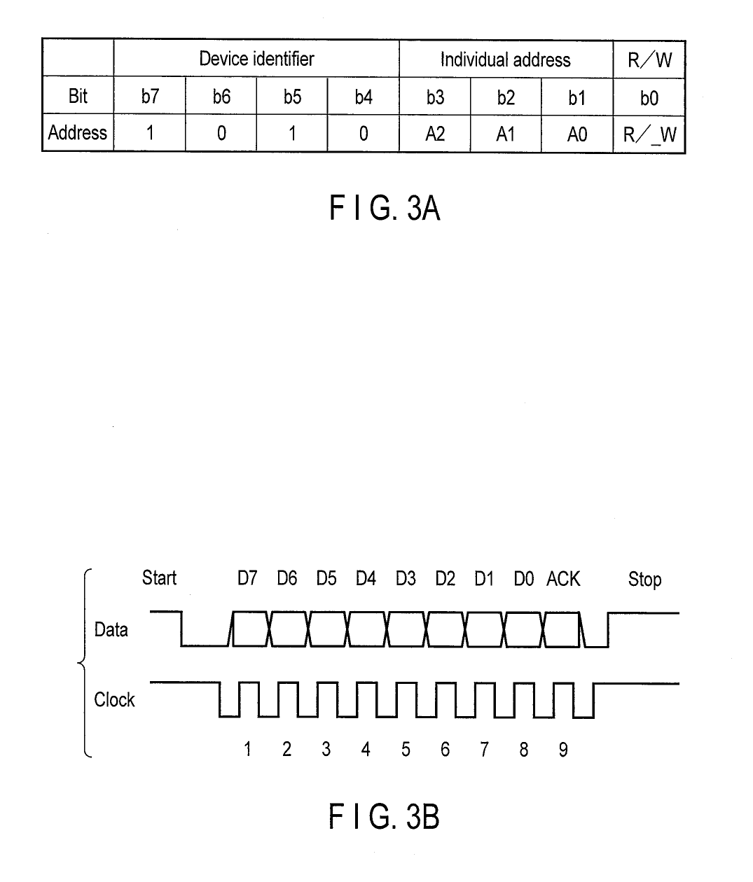

FIGS. 3A and 3B are figures for describing the aforementioned I²C interface. A bus of the I²C interface (I²C-BUS) is comprised of two communication lines for clock and data, the clock being output from a master device and pulled up, and the data being used in two-way communication between the master device and a slave device.

FIG. 3A shows a configuration example of a slave address. The slave address is 8 bits length, and the high-order 4 bits are fixed according to the type of the device. The lowest order bit (b0) indicates Write when it is 0, and indicates Read when it is 1. Therefore, in the slave address, bits which can be actually used are from 1 to 3, namely, b1, b2, and b3.

FIG. 3B is a schematic view of the timing of two lines, and as shown in the upper side part of FIG. 3B, data transfer is started as a level value of a signal on the data line becomes low, and the data is sequentially transmitted in the order of high-order bits to low-order bits. The transfer is brought into a stop state as the level value of the signal on the data line becomes high. The timing of the corresponding clock line is as shown in the lower side part of 3B. While FIG. 3B shows an example of 1 byte transfer, if transmission of data and an ACK are repeated for several times until the stop state is reached, it is possible to make the first byte represent the slave address and the remaining bytes represent the specific communication.

FIG. 4 is a block diagram of another example of the embodiment.

As compared to FIG. 2, FIG. 4 shows a case where the control signals of bus switch BSW1, bus switch BSW2, transistor TA1, and transistor TA2 are replaced with controls signal EN1 and control signal EN2, which are the control signals of the power switch. It is possible to obtain an advantage similar to the advantage obtained by the case of FIG. 2. Se3 is equivalent to Se1 shown in FIG. 2, and Se4 is equivalent to Se2 of FIG. 2 except for the replacement by control signals EN1 and control signal EN2.

As described above, as a method for terminating the bus line for power-saving operation, a problem that the value of terminating resistance is varied if power of devices which are not working is turned on/off during energization of the system from the standpoint of power conservation has been resolved.

According to this embodiment, by using a method for correcting the value of terminating resistance by utilizing a change in the voltage of a device power source, means and components which were necessary in the past, for example, means for detecting load devices and a control circuit, such as a decode circuit, for resistance value adjustment, became unnecessary.

That is, as an advantage of the embodiment as compared to prior art, with the method for correcting the value of terminating resistance by using the change in the voltage of the device power source, the present embodiment eliminated means for detecting the number of loads and a decode circuit. Further, since the value of terminating resistance is switched by using the change in the voltage of the device power source, there is no need to either detect the number of boards or create a mechanism for adjusting the terminating resistance at the load side. The present embodiment improves variations in values of terminating resistance caused by dynamic electric connection/disconnection of the devices.

### (Gist of Embodiment and Summary of Main Points)

In a system in which a plurality of devices, which are respectively connected to a single bus line of a host bus system with a plurality of device buses, are configured to dynamically turn on/off each of power sources for the purpose of power saving, and to electrically connect/disconnect each of the devices and the bus line at the same time, the present embodiment provides the means for improving the variations in the values of terminating resistance caused by the dynamic electric connection/disconnection of the devices to the bus line.

(1) When a part of the terminating resistors is disconnected from the bus line as a result of the power of the device being turned off and the device being in the electrically disconnected state, by adding a new resistor to the bus line, it is made sure that overall combined resistance is not changed.

(2) When the part of the terminating resistors is reconnected to the bus line as a result of the power of the device being turned on and the device being in the electrically connected state, by separating the resistor connected to the bus line stated in 1 above, it is made sure that overall combined resistance is not changed.

(3) The connection/disconnection of the resistor to/from the bus line stated in 1 and 2 above is carried out according to the change in the voltage of the device power source or a signal controlling the voltage of the device power source.

(4) A value of resistance of the resistor connected to the bus line in 1 above is made the same as that of the nonconnected terminating resistor.

(5) The place where the resistor to be connected to the bus line is connected in 1 above is the bus line which is not brought into disconnection by the device. Normally, the resistor is connected to the place where a host controller is directly connected.

(6) The system comprises means such as a switch for cutting off electric connection between the device and the bus line, or a device component which provides an equivalent function.

(7) Simultaneously with turning off the power source of the device, the electric connection between the device and the bus line is cut off.

The present invention is not limited to the embodiment described above but the constituent elements of the invention can be modified in various manners without departing from the spirit and scope of the invention.

Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

What is claimed is:

1. A semiconductor device comprising:
a first device;
a load switch configured to feed power to the first device when a control signal is active;
a device bus to which the first device is connected; and
a device bus terminating resistor configured to terminate the device bus.

2. The semiconductor device of claim 1, further comprising a bus switch configured to connect a host bus and the device bus when the control signal is active or when the load switch is in a feed state.

3. A switching circuit comprising:
the semiconductor device of claim 1;
a bus switch configured to connect a host bus and the device bus when the control signal is active or when the load switch is in a feed state; and
a host bus terminating resistor configured to terminate the host bus when the host bus and the device bus are disconnected.

4. The switching circuit of claim 3,
wherein the host bus terminating resistor substitutes for the device bus terminating resistor with a value of resistance equivalent to a value of resistance of the device bus terminating resistor.

5. A switching circuit comprising:
a semiconductor device of claim 2; and
a host bust terminating resistor configured to terminate the host bus when the host bus and the device bus are disconnected.

6. The switching circuit of claim 5,
wherein the host bus terminating resistor substitutes for the device bus terminating resistor with a value of resistance equivalent to a value of resistance of the device bus terminating resistor.

7. A switching circuit comprising:
a device;
a load switch configured to feed power to the device when a control signal is active;
a device bus to which the device is connected;
a device bus terminating resistor configured to terminate the device bus;
a bus switch configured to connect a host bus and the device bus when the control signal is active or when the load switch is in a feed state; and
a host bus terminating resistor configured to terminate the host bus when the host bus and the device bus are disconnected.

8. The switching circuit of claim 7,
wherein the host bus terminating resistor substitutes for the device bus terminating resistor with a value of resistance equivalent to a value of resistance of the device bus terminating resistor.

9. An electronic apparatus comprising the switching circuit of claim 3.

10. The electronic apparatus of claim 9,
wherein the host bus terminating resistor substitutes for the device bus terminating resistor with a value of resistance equivalent to a value of resistance of the device bus terminating resistor.

11. An electronic apparatus comprising the switching circuit of claim 5.

12. The electronic apparatus of claim 11,
wherein the host bus terminating resistor substitutes for the device bus terminating resistor with a value of resistance equivalent to a value of resistance of the device bus terminating resistor.

13. An electronic apparatus comprising the switching circuit of claim 7.

14. The electronic apparatus of claim 13,
wherein the host bus terminating resistor substitutes for the device bus terminating resistor with a value of resistance equivalent to a value of resistance of the device bus terminating resistor.
